(19) United States
(12) Patent Application Publication
(10) Pub. No.: US 2023/0314848 A1
(43) Pub. Date: Oct. 5, 2023

(54) TRANSPARENCY-ADJUSTABLE FILM USING COMPRESIVE STRAIN AND TRANSPARENCY-ADJUSTING APPARATUS

(71) Applicant: Korea Advanced Institute of Science and Technology, Daejeon (KR)

(72) Inventors: Seokwoo JEON, Daejeon (KR); Haomin CHEN, Daejeon (KR); Donghwi CHO, Daejeon (KR)

(73) Assignee: Korea Advanced Institute of Science and Technology, Daejeon (KR)

(21) Appl. No.: 18/146,555

(22) Filed: Dec. 27, 2022

(30) Foreign Application Priority Data
Mar. 30, 2022 (KR) 10-2022-0039422

(51) Int. Cl. G02F 1/01

(52) U.S. Cl. CPC G02F 1/0128; G02F 2202/022

(57) ABSTRACT

A transparency-adjusting apparatus includes a transparency-adjustable film including a polymer and an array of pores that are three-dimensionally ordered and connected to each other, and a compressive-strain adjusting part that adjusts a compressive strain of the transparency-adjustable film in a vertical direction. A transparency of the transparency-adjustable film varies depending on the compressive strain. The pores are arranged to tilt from the vertical direction.

### CROSS-REFERENCE TO RELATED APPLICATION

This application claims priority to and benefits of Korean Patent Application No. 10-2022-0039422 under 35 U.S.C. § 119 filed on Mar. 30, 2022 in the Korean Intellectual Property Office, the entire contents of which are incorporated herein by reference.

### BACKGROUND

### 1. Technical Field

Embodiments relate to a transparency-adjustable film. More particularly, Embodiments relate to a transparency-adjustable film using compressive strain and a transparency-adjusting apparatus.

### 2. Description of the Related Art

Conventional transparency-adjusting technologies such as n electrochromic device, a suspended particle device (SPD) or the like is required to apply an electric field to control alignment of scattering units dispersed therein. Thus, they have complicated configuration, cost high and are hardly applicable to a conventional window system. In addition, since photochromic and thermochromic technologies are based on chemical changes, their durability and stability may be relatively poor. Furthermore, because of slow reaction rates and inevitable color changes, they have limited applications such as sunglasses or the like.

As a technology that may be free from the above problems, optical modulation technologies controlled by mechanical deformation according to a simple principle has recently been focused. For example, a stretchable optical film capable of adjusting a transparency depending on a strain by using a light scattering phenomenon at a structural interface, which occurs when light is incident on a scattering structure such as a micro or nano-structure (wrinkle, crack, pillar, hole, particle, etc.), has been being studied.

Recently, in order to increase optical modulation performance of the stretchable optical film, a stretchable optical film having a three-dimensional scattering structure formed by a hetero interface has been being studied. However, a large tensile force and a large space are required so that the stretchable optical film having a three-dimensional scattering structure may have sufficient optical modulation performance. Furthermore, many processes are required to form a hetero interface.

### PRIOR ART

### Patent Literature

1. Korean Patent Publication 10-2021-0154389
2. Korean Granted Patent 10-2304949
3. Korean Granted Patent 10-1902380

### Non-Patent Literature

1. Advanced Science 7, 11, 1903708 (2020)
2. ACS Nano 14, 9, 12173 (2020)
3. ACS Applied Materials and Interfaces 12, 13, 15695

### SUMMARY

One object of the invention is to provide a transparency-adjustable film that is capable of providing large optical modulation performance using compressive strain and being easily manufactured.

Another object of the invention is to provide a transparency-adjusting apparatus including the transparency-adjustable film.

According to an embodiment of the invention, a transparency-adjustable film includes a polymer and an array of pores that are three-dimensionally ordered and connected to each other. The pores have a shape extending in a direction, and an extending direction of the pores tilts from a direction vertical to a plane direction of the transparency-adjustable film.

According to an embodiment of the invention, a transparency-adjusting apparatus includes a transparency-adjustable film including a polymer and an array of pores that are three-dimensionally ordered and connected to each other, and a compressive-strain adjusting part that adjusts a compressive strain of the transparency-adjustable film in a vertical direction. A transparency of the transparency-adjustable film varies depending on the compressive strain. The pores are arranged to tilt from the vertical direction.

In an embodiment, the transparency-adjustable film includes polydimethylsiloxane.

In an embodiment, the pores have a shape extending in a direction, wherein a tilting angle of the pores is defined by an angle between the extending direction and the vertical direction.

In an embodiment, the tilting angle of the pores is 10° to 45°.

In an embodiment, a porosity of the transparency-adjustable film is 30% to 70%.

In an embodiment, the transparency-adjustable film includes a porous region having the pores and a solid region substantially without pores.

In an embodiment, the transparency-adjusting apparatus further includes a first substrate disposed on a first surface of the transparency-adjustable film, and a second substrate disposed on a second surface of the transparency-adjustable film.

In an embodiment, the compressive-strain adjusting part includes a movement member combined with the first substrate and a movement guide combined with the second substrate. The movement member moves along the movement guide in the vertical direction to adjust the compressive strain of the transparency-adjustable film.

In an embodiment, the compressive-strain adjusting part includes a first transparent electrode between the transparency-adjustable film and the first substrate, and a second transparent electrode between the transparency-adjustable film and the second substrate. The first transparent electrode and the second transparent electrode are connected to a voltage-applying part to adjust the compressive strain of the transparency-adjustable film depending on polarities of voltages applied to the first transparent electrode and the second transparent electrode and on a difference between the voltages.

In an embodiment, the transparency-adjusting apparatus further includes a cover member that covers edges of the first substrate, the second substrate and the transparency-adjustable film. The cover member includes a first portion facing an upper surface of the first substrate, a second portion facing a lower surface of the second substrate, and a third portion connecting the first portion and the second portion to each other. The compressive-strain adjusting part is disposed between the first portion of the cover member and the first substrate, and a vertical length of the compressive-strain adjusting part varies in response to an electric signal or a power applied thereto to adjust the compressive strain of the transparency-adjustable film

According to embodiments of the invention, a transparency may be adjusted by a transparency-adjustable film having a simple structure. Furthermore, since a transparency may be adjusted by a compressive strain much smaller than a tensile strain, configuration of a transparency-adjusting apparatus may be easily designed.

### BRIEF DESCRIPTION OF THE DRAWINGS

FIGS. 1 and 3 are lateral views illustrating a transparency-adjusting apparatus according to an embodiment.

FIGS. 2 and 4 are enlarged cross-sectional views illustrating a transparency-adjustable film according to an embodiment.

FIG. 5 is a lateral view illustrating a transparency-adjusting apparatus according to another embodiment.

FIGS. 6, 7, 8, 9, 10 and 11 are cross-sectional views illustrating a method for fabricating a transparency-adjustable film according to embodiments.

FIG. 12 is an enlarged cross-sectional view illustrating a transparency-adjustable film according to an embodiment.

FIGS. 13, 14, 15, 16, 17 and 18 are cross-sectional views illustrating a method for fabricating the phase mask having a supporting portion with a prism shape, which is illustrated in FIG. 8.

FIG. 19 shows scanning electron microscopy (SEM) photographs showing cross-sections of the transparency-adjustable films obtained with different incident angles in Example 1.

FIG. 20 is a graph showing a refracted angle of pores in the transparency-adjustable films obtained with different incident angles in Example 1.

FIG. 21 show graphs showing transparency variance depending on a compressive displacement (Displacement) (a) and a transparency variance (ΔT/ε) to a compressive strain (Strain) (b), of the transparency-adjustable films of Example 1 and Comparative Example 1.

FIG. 22 is a graph showing a transmittance depending on a wavelength of a light and displacement of the transparency-adjustable film (refracted angle: 40°) of Example 1.

### DETAILED DESCRIPTION OF THE EMBODIMENTS

Various embodiments will be described more fully hereinafter with reference to the accompanying drawings, in which some embodiments are shown. The invention may, however, be embodied in many different forms and should not be construed as limited to the embodiments set forth herein. Rather, these embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Transparency-Adjustable Film and Transparency-Adjusting Apparatus

Embodiments of the present invention provide a transparency-adjustable film and a transparency-adjusting apparatus, which are capable of controlling a scattering boundary through a compressive strain thereby effectively controlling a transparency (transmittance).

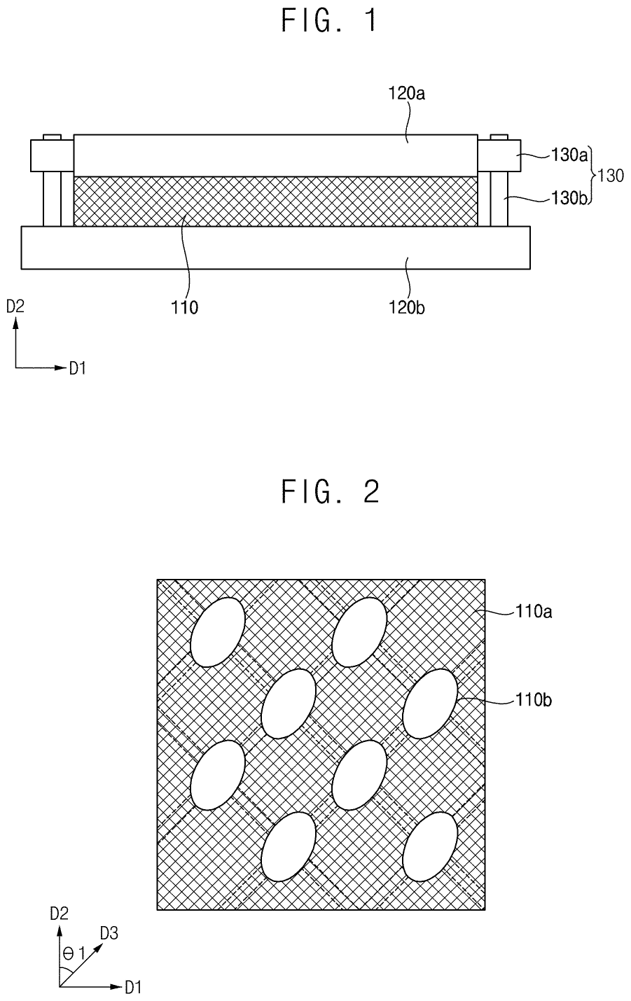

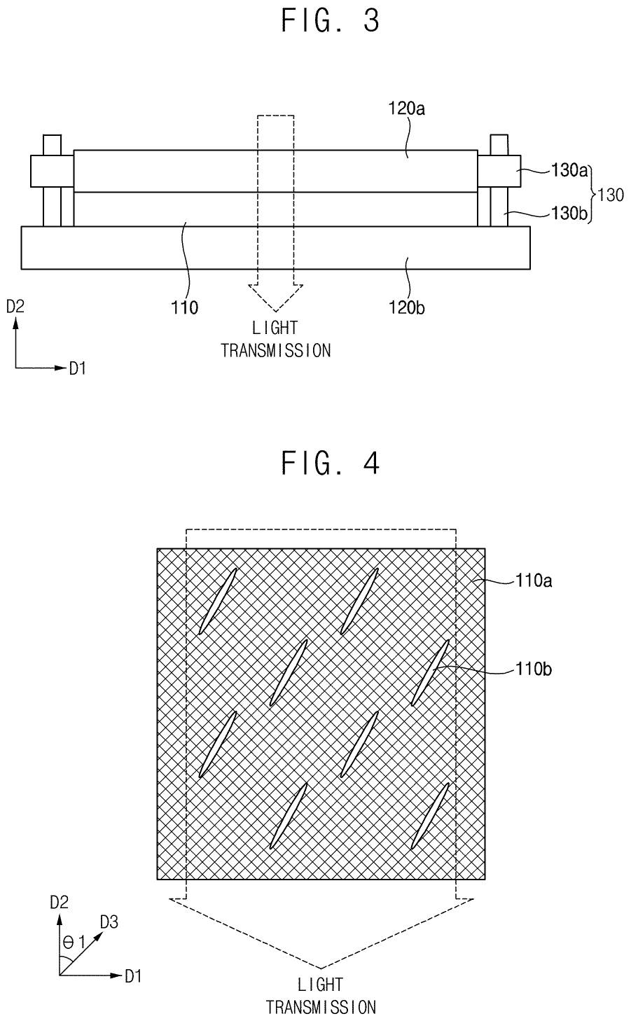

FIGS. 1 and 3 are lateral views illustrating a transparency-adjusting apparatus according to an embodiment. FIGS. 2 and 4 are enlarged cross-sectional views illustrating a transparency-adjustable film according to an embodiment.

Referring to FIG. 1, a transparency-adjusting apparatus includes a first substrate 120a, a second substrate 120b spaced apart from the first substrate 120a, a transparency-adjustable film 110 disposed between the first substrate 120a and the second substrate 120b, and a compressive-strain adjusting part 130 that may apply a compressive force to the transparency-adjustable film 110.

The transparency-adjustable film 110 may be an elastic film having a porous structure. For example, the transparency-adjustable film 110 may include a polymer having a high elasticity with flexibility. For example, the transparency-adjustable film 110 may include polydimethylsiloxane (PDMS), polyurethane, styrene-isoprene-styrene (SIS), styrene-butadiene-styrene (SBS), styrene-ethylene-butylene-styrene (SEBS) or the like. In an embodiment, the transparency-adjustable film 110 may include polydimethylsiloxane.

In an embodiment, the transparency-adjustable film 110 may have a porous area including pores 110b that are three-dimensionally ordered and connected to each other. A portion surrounding the pores 110b and including a polymer may be referred as to an elastic portion 110a.

The pores may be three-dimensionally arranged along a plane direction D1 and a vertical direction D2 of the transparency-adjustable film 110. Pores adjacent to each other may be connected to each other through a sub-pore. Furthermore, the pore network of the transparency-adjustable film 110 is connected to an exterior so that an air in the transparency-adjustable film 110 may move out, or an external air may enter the transparency-adjustable film 110.

The transparency-adjustable film 110 scatters a light incident thereon with a porous structure. Thus, the transparency-adjustable film 110 may be semi-transparent or opaque when a compressive force is not applied thereto.

When a compressive force is applied to the transparency-adjustable film 110, a size of the pores 110b is reduced. When the size of the pores 110b is reduced, the number of scattering sites formed by an interface between an air and a polymer so that an entire transparency of the transparency-adjustable film 110 may be increased. When the compressive force is removed from the transparency-adjustable film 110, the pores 110b are recovered so that scattering sites are increased to reduce a transparency. Since the transparency-adjustable film 110 includes a material having a high elasticity (resilience) and a high flexibility, such deformation may be repeatedly performed. Thus, adjusting a compressive force applied to the transparency-adjustable film 110 or adjusting a compressive strain of the transparency-adjustable film 110 may adjust a transparency of the transparency-adjustable film 110. Furthermore, a thickness of the transparency-adjustable film 110 may be changed, or a plurality of transparency-adjustable films may be stacked to adjust a changeable range of a transparency for the transparency-adjustable film 110.

For example, when a plurality of transparency-adjustable films are stacked, light-scattering of the stack, which are not compressed, is increased, a transparency of the whole stack is reduced. The transparency-adjustable film 110 has a high transparency when compressed, and even when a plurality of transparency-adjustable films are stacked, the stack may have a high transparency when compressed. Thus, it is possible to increase transparency modulation range through stacking a plurality of transparency-adjustable films.

In an embodiment, the pores 110b may have a shape extending in a direction. For example, a cross-section of the pores 110b may have an oval shape, a rectangular shape or the like. In an embodiment, an extending direction D3 of the pores 110b may tilt (incline) from the vertical direction D2 of the transparency-adjustable film 110. For example, the extending direction D3 of the pores 110b may tilt from the vertical direction D2 of the transparency-adjustable film 110 by 0° to 45°. When the tilting angle θ1 of the pores is larger than 45°, a contrast between constructive interference area and destructive interference area in a three-dimension (3D) light-exposure process for fabricating the transparency-adjustable film 110 is reduced. Thus, a well-ordered 3D structure is hardly formed. Preferably, the tilting angle θ1 of the pores may be 10° to 45°, and more preferably 30° to 40°.

For example, a thickness of the transparency-adjustable film 110 may be 5 μm to 1 mm. When a thickness of the transparency-adjustable film 110 is excessively small, a maximum light-blocking ratio and a transparency difference between a normal state, when a compressive force is not applied, and a compressed state may be reduced. When a thickness of the transparency-adjustable film 110 is excessively large, a compressive force required for a desired transparency may be excessively increased. For example, a thickness of the transparency-adjustable film 110 may be 10 μm to 1,000 μm, 10 μm to 500 μm, or 10 μm to 100 μm.

The exemplified thickness of the transparency-adjustable film 110 may be a thickness of a porous region. When the transparency-adjustable film 110 includes a solid region in addition to the porous region, a proper thickness of the transparency-adjustable film 110 may be further increased.

In an embodiment, a porosity of the transparency-adjustable film 110 may be 30% to 70% (volume %). When a porosity of the transparency-adjustable film 110 is excessively small or large, a transparency difference (contrast) between the normal state and the compressed state.

For example, in a cross-sectional view, a length of a pore unit along a vertical direction or an extending direction may be 1 μm to 10 μm, and a width thereof along a horizontal direction or a perpendicular direction to the extending direction may be 0.1 μm to 1 μm. Furthermore, a periodicity (pitch) of an array of pore units along a horizontal direction may be 0.1 μm to 10 μm. However, embodiments are not limited thereto. A size and a periodicity may be varied depending on a thickness, a porosity, a tilting angle of pores or the like, of the transparency-adjustable film.

In an embodiment, a 3D array of the pores may form a body-centered tetragonal (BCT) structure. For example, the pores may form an inclining BCT structure.

However, embodiments are not limited thereto. Array of the pores may form a face-centered cubic structure or a simple cubic structure.

In an embodiment, the first substrate 120a and the second substrate 120b may be a transparent rigid substrate. When the first substrate 120a and the second substrate 120b have a high flexibility, they hardly apply a compressive force to the transparency-adjustable film 110. For example, the first substrate 120a and the second substrate 120b may each include glass, quartz, sapphire or the like. The first substrate 120a may be disposed on a first surface (upper surface) of the transparency-adjustable film 110, and the second substrate 120b may be disposed on a second surface (lower surface) of the transparency-adjustable film 110.

In an embodiment, the compressive-strain adjusting part 130 may include a movement member 130a and a movement guide 130b. The movement member 130a may include means for moving such as a motor, or may be coupled to a power supply part through another connection member. For example, the movement guide 130b may be combined with the second substrate 120b so that position thereof may be fixed to the second substrate 120b. The movement member 130a may move in the vertical direction D2 along the movement guide 130b in response to an electric signal or a power, which is applied thereto. The first substrate 120a may be moved toward to the second substrate 120b by the movement member 130a so that a compressive force may be applied to the transparency-adjustable film 110. The compressed transparency-adjustable film 110 may have a transparency increased depending on a compressive strain thereof.

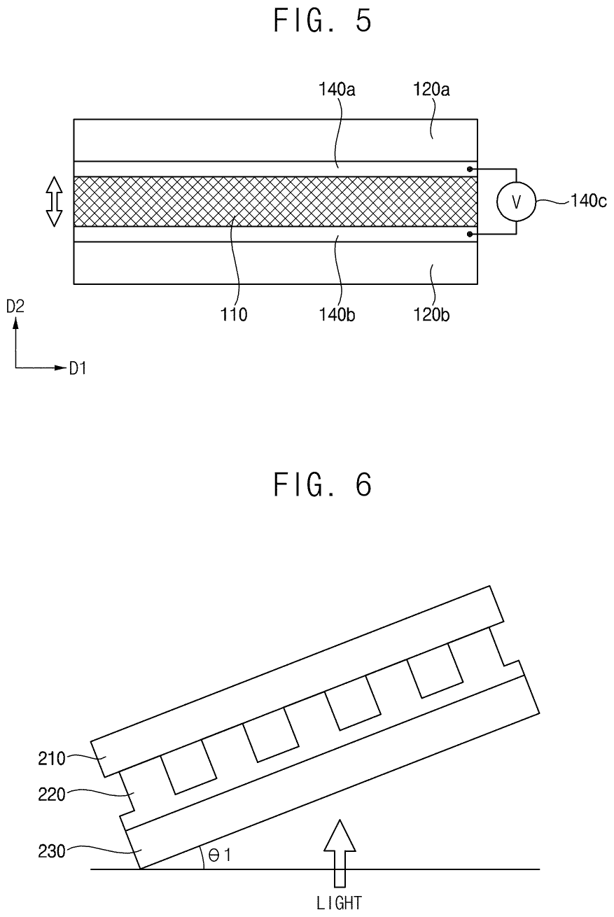

FIG. 5 is a lateral view illustrating a transparency-adjusting apparatus according to another embodiment.

Referring to FIG. 5, a transparency-adjusting apparatus includes a first substrate 120a, a second substrate 120b spaced apart from the first substrate 120a, and a transparency-adjustable film 110 disposed between the first substrate 120a and the second substrate 120b. The transparency-adjusting apparatus includes a compressive-strain adjusting part. For example, the compressive-strain adjusting par include a first transparent electrode 140a disposed between the first substrate 120a and the transparency-adjustable film 110, and a second transparent electrode 140b disposed between the second substrate 120b and the transparency-adjustable film 110.

In an embodiment, the first transparent electrode 140a and the second transparent electrode 140 may be each electrically connected to a voltage-applying part 140c so that voltages with opposite polarities may be applied to the first transparent electrode 140a and the second transparent electrode 140b depending on operation of the voltage-applying part 140c. When voltages with opposite polarities are applied to the first transparent electrode 140a and the second transparent electrode 140b, a force of gravity (attraction) due to an electrostatic force (Coulomb's force) is applied to the first transparent electrode 140a and the second transparent electrode 140b so that the first transparent electrode 140a and the second transparent electrode 140b are pulled toward each other. As a result, a compressive force is applied to the transparency-adjustable film 110. The compressive force may be adjusted depending on a difference between the voltages applied to first transparent electrode 140a and the second transparent electrode 140.

Since the transparency-adjustable film 110 is flexible and has a small thickness, a compressive strain may be caused by the compressive force thereby changing a transparency of the transparency-adjustable film 110.

In an embodiment, the first transparent electrode 140a and/or the second transparent electrode 140b may include a conductive polymer such as poly(3,4-ethylenedioxythiophene)-poly(styrenesulfonate) (PEDOT:PSS). However, embodiments are not limited thereto, and various transparent conductive materials may be used for the first transparent electrode 140a and/or the second transparent electrode 140b. For example, the first transparent electrode 140a and/or the second transparent electrode 140b may include indium tin oxide, indium zinc oxide, carbon nano-tube, silver nano-wire or the like.

The first substrate 120a or the second substrate 120b may have a plate shape extending in a horizontal direction, and may be enlarged depending on application of the transparency-adjusting apparatus. Thus, if the compressive force is focused on an edge of the first substrate 120a or the second substrate 120b, the substrate 120a or the second substrate 120b may bend thereby causing non-uniform compressive strain of the transparency-adjustable film 110.

According to an embodiment, a uniform compressive force may be applied to a large-sized transparency-adjustable film by using an electrostatic force between transparent electrodes, and a compressive force may be easily controlled by a voltage-applying part. Furthermore, such configuration may allow a thinner substrate to be used or may allow omission of substrates.

However, embodiments are not limited thereto. For example, a material having a larger bending modulus may be used for a substrate, or a thickness of a substrate may be increased, in order to prevent a substrate from bending.

According to embodiments, a transparency may be adjusted by a transparency-adjustable film having a simple structure.

Furthermore, since a transparency may be adjusted by a compressive strain much smaller than a tensile strain, configuration of a transparency-adjusting apparatus may be easily designed.

Method for Fabricating a Transparency-Adjustable Film

FIGS. 6, 7, 8, 9, 10 and 11 are cross-sectional views illustrating a method for fabricating a transparency-adjustable film according to embodiments. FIG. 12 is an enlarged cross-sectional view illustrating a transparency-adjustable film according to an embodiment.

A proximity-field nano-patterning (PnP) method may be used for fabricating the transparency-adjustable film having a 3D porous structure, which is illustrated in FIG. 2. Furthermore, an inclining light-exposure process may be performed to adjust a tilting angle (extending direction of pores) of the 3D porous structure. Embodiments for performing the inclining light-exposure process may be explained with reference to FIGS. 6, 7 and 8.

Referring to FIG. 6, a photosensitive film 210 is disposed to contact a phase mask 220. For example, the phase mask 220 may be disposed on a transparent supporting member 230, and the photosensitive film 210 may be disposed on the phase mask 220. The phase mask 220 may have a convexo-concave surface with a pattern. The photosensitive film 210 may be disposed to contact the convexo-concave surface. For example, the convexo-concave surface may have various shapes such as a lattice shape, a wire grid shape, a circular pillar array, a rectangular pillar array or the like.

For example, a glass substrate or the like may be used for the transparent supporting member 230. However, embodiments are not limited thereto, and the transparent supporting member 230 may include various materials having a proper transparency and a hardness, such as quartz, polymers or the like.

The transparent supporting member 230 may have a surface inclining by a predetermined angle. Thus, an incident angle of a light irradiated onto the photosensitive film 210 may be adjusted.

The photosensitive film 210 may be formed from a photoresist composition. For example, after a photoresist composition may be coated on a substrate, the photoresist composition may be soft-baked, for example, at about 50° C. to about 100° C. to form the photosensitive film 210.

For example, the photoresist composition for forming the photosensitive film 210 may include an organic-inorganic hybrid material, a hydrogel, a phenolic resin, an epoxy resin or the like, which may be cross-linked by light exposure. For example, SU-8 series, KMPR series, ma-N 1400, which are from MicroChem, NR5-6000p from Futurrex or the like may be used for the photoresist composition.

Thereafter, the photosensitive film 210 is exposed to a light through the phase mask 220. For example, a light may be irradiated onto a surface of the phase mask 220, which is opposite to the convexo-concave surface, through the transparent supporting member 230.

The phase mask 220 may include a flexible elastic material. Thus, when the phase mask 220 contacts the photosensitive film 210, the phase mask 220 may spontaneously adhere to or conformal-contact a surface of the photosensitive film 210 by Van der Waals force.

For example, when a laser having a wavelength similar to a pattern periodicity of the phase mask 220 is irradiated onto the phase mask 220, a three-dimensionally distributed light may be formed by Talbot effect. When the photosensitive film 210 is formed from a negative-tone photoresist composition, cross-linking of a resin may be selectively caused in a portion where light intensity is relatively high by constructive interference, and may be hardly caused in a remaining portion where light intensity is relative low. Thus, the remaining portion, which is barely or not light-exposed, may be removed in a developing process. As a result, a nano-structure having channels arranged with a periodicity of nanometers to micrometers may be obtained. After the developing process, the photosensitive film may be dried.

For example, the phase mask 220 may include a material such as polydimetylsiloxane (PDMS), polyurethane acrylate (PUA), perfluoropolyether (PFPE) or the like.

For example, an exposing dose energy of the light-exposure process may be about 10 mJ/cd to about 500 mJ/cd depending on a thickness of the photosensitive film 210. For example, the light may be a UV ray or the like. For example, a light having a wavelength of about 300 nm to about 400 nm may be used.

The light-exposed photosensitive film 210 may be post-baked at about 50° C. to about 100° C. A time for baking may be properly adjusted. For example, the light-exposed photosensitive film 210 may be heated for about 5 minutes to about 30 minutes.

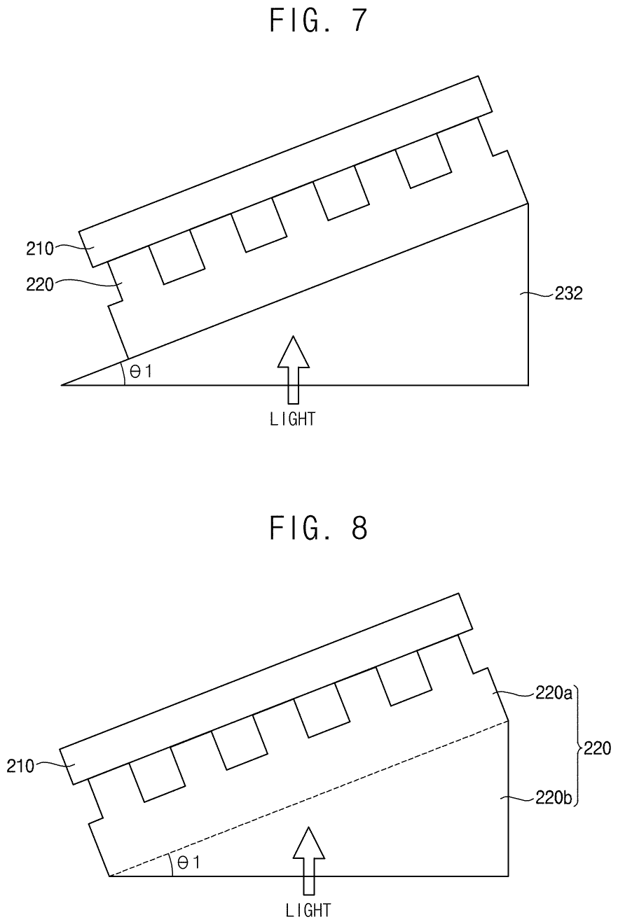

Referring to FIG. 7, a prism 232 having an inclining surface may be used for adjusting an incident angle of a light irradiated onto the phase mask 220. The prism 232 may have a bottom surface parallel to a ground surface and an inclining surface forming an acute angle to the bottom surface. The light may be incident onto the bottom surface in a direction vertical to the bottom surface, and may enter the phase mask 220 through the inclining surface. An incident angle of a light entering the phase mask 220 and the photosensitive film 210 may be determined depending on an inclining angle θ2 of the inclining surface.

In an embodiment, the prism 232 may preferably include a material such that a refractivity difference between the prism 232 and the phase mask 220. When a refractivity difference between the prism 232 and the phase mask 220 is large, an incident angle of the light entering the photosensitive film 210 may be hardly adjusted. Furthermore, reflection and scattering of alight at an interface between the phase mask 220 and the prism 232 may be increased so that a contrast of 3D light distribution may be reduced.

Referring to FIG. 8, the phase mask 220 may include a lattice portion 220a and a supporting portion 220b. The lattice portion 220a includes a convexo-concave surface contacting the photosensitive film 210. The supporting portion 220b may have a prism shape. Patterns periodically arranged along an inclining surface of the supporting portion 220b may be formed at the convexo-concave surface. An incident angle of a light entering the photosensitive film 210 may be determined depending on an inclining angle θ2 of the inclining surface of the supporting portion 220b.

The lattice portion 220a and the supporting portion 220b may include a substantially same material. For example, the lattice portion 220a and the supporting portion 220b may include PDMS. As a result, an incident angle of a light entering the photosensitive film 210 may be precisely adjusted, and a contrast of 3D light distribution may be prevented from being reduced due to increase of reflection and scattering of a light at an interface between different materials.

In an embodiment, the lattice portion 220a and the supporting portion 220b may include a same-based polymer with different modulus. For example, the lattice portion 220a may have a modulus larger than a modulus of the supporting portion 220b. Such configuration may improve a profile of a convex-concave structure, and may maintain an entire flexibility of the phase mask 220. For example, PDMS having more hard segments may be obtained by reaction of PDMS having a hydroxyl end group with diisocyanate and a chain extender (diol or diamine) in order to the lattice portion 220a having a modulus larger than a modulus of the supporting portion 220b.

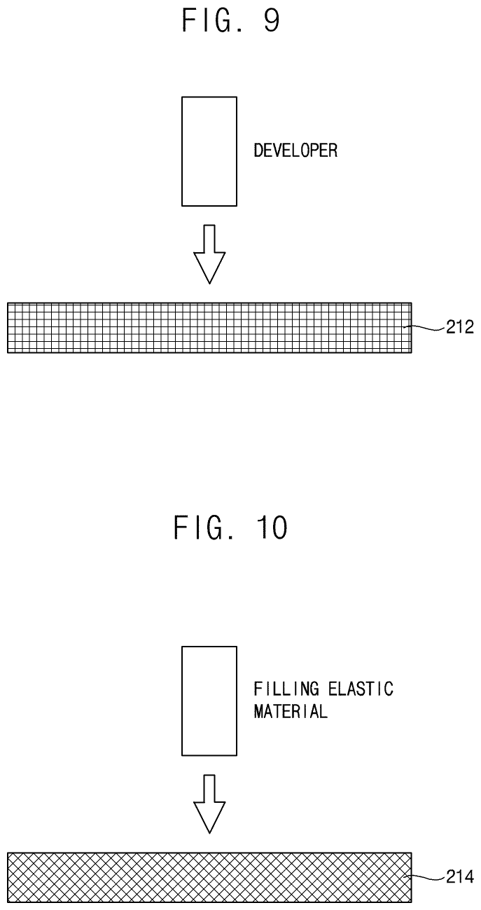

Referring to FIG. 9, the photosensitive film 210 exposed to the three-dimensionally distributed light is developed to form a 3D porous template 212.

For example, when the photosensitive film 210 is formed from a negative-tone photoresist composition, a portion that is not or hardly exposed to a light is removed by a developer so that a portion that is exposed to a light remains. As a result, the 3D porous template 212 including channels corresponding to the removed portion may be obtained.

The developer may include propylene glycol monomethyl ether acetate (PGMEA), ethyl lactate, diacetone alcohol, tetramethylammonium hydroxide (TMAH), a developing solution for Su-8 or the like.

After developed, the 3D porous template 212 may be rinsed by deionized water, an alcohol such as ethanol or isopropyl alcohol, or the like.

Referring to FIG. 10, an elastic material is filled in the 3D porous template 212. For example, a polymer precursor composition including an oligomer or a monomer is filled in the 3D porous template 212 and then cured. In another embodiment, a polymer solution including a polymer such as PDMS may be filled in the 3D porous template 212 and then dried.

In order to uniformly fill the elastic material in the 3D porous template 212, the filling process may be performed in a vacuum condition, or a negative pressure may be provided to the 3D porous template 212.

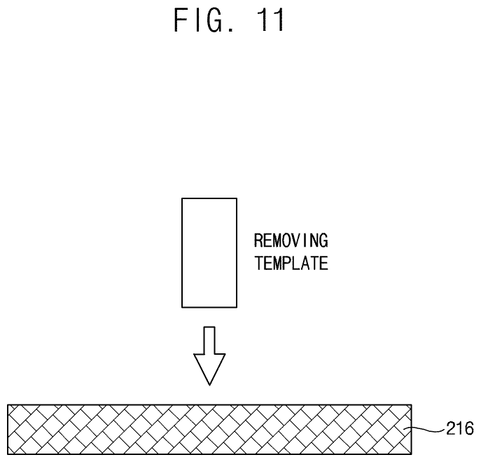

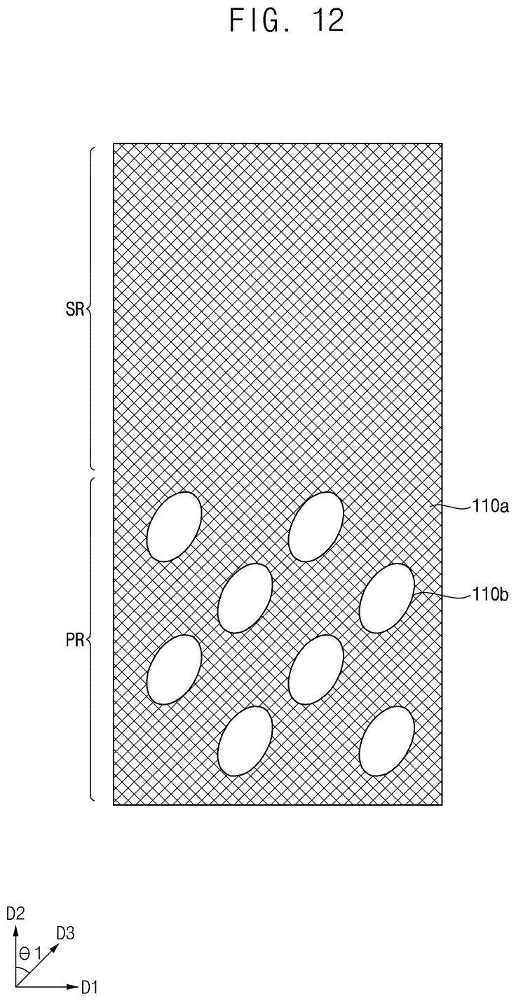

Referring to FIG. 11, the 3D porous template 212 is removed to obtain a porous elastic film 216 including pores that are three-dimensionally ordered and connected to each other. A proper stripper may be selected and used for removing the 3D porous template 212 depending on a material of the 3D porous template 212.

The porous elastic film 216 may have a substantially same configuration as the transparency-adjustable film illustrated in FIGS. 1 and 2.

Referring to FIG. 12, a transparency-adjustable film (porous elastic film) includes a porous region PR and a solid region SR. The porous region PR has an elastic portion 110a including an elastic material and pores 110b defined in the elastic portion 110a. The solid region PR does not substantially include pores, and may be filled with an elastic material.

In a cross-sectional view, an extending direction D3 of the pores 110b may tilt from the plane direction D1 and the vertical direction D2 of the transparency-adjustable film. For example, the extending direction D3 of the pores 110b may tilt from the vertical direction D2 of the transparency-adjustable film by 0° to 45°. The tilting angle θ1 of the pores 110b may be determined by a light exposure angle in the process of forming the transparency-adjustable film. For example, the tilting angle θ1 of the pores 110b may be similar to the light exposure angle in the process of forming the transparency-adjustable film.

The solid region SR may function as to reinforce a strength of the transparency-adjustable film. For example, the solid region SR may be formed from an elastic material coated above the 3D porous template 212 when the elastic material is filled in the 3D porous template 212.

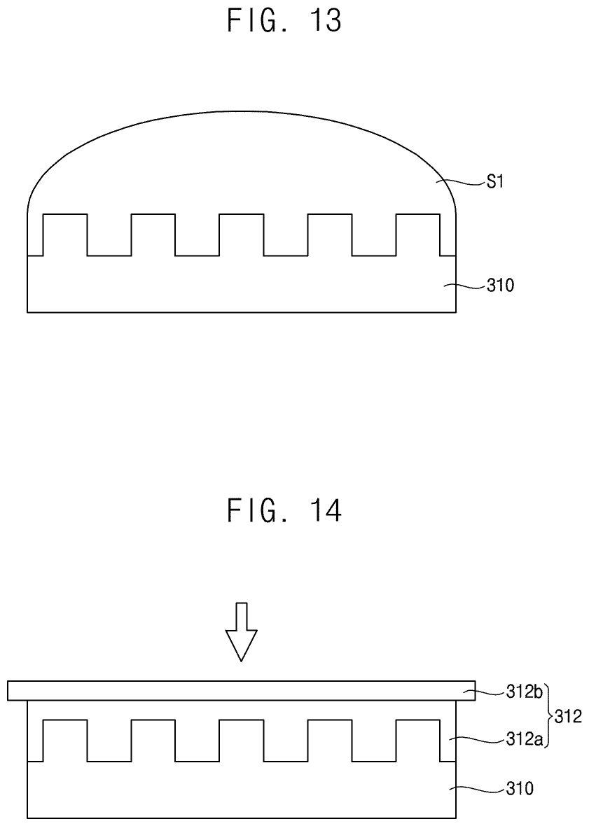

FIGS. 13, 14, 15, 16, 17 and 18 are cross-sectional views illustrating a method for fabricating the phase mask having a supporting portion with a prism shape, which is illustrated in FIG. 8.

Referring to FIG. 13, a first polymer solution S1 is coated on a convex-concave surface of a first template 310. The convex-concave surface has a lattice pattern. For example, the first polymer solution S1 may include polyurea acrylate or a precursor (monomer or oligomer) for forming polyurea acrylate.

The first template 310 may include a rigid material such as silicon or the like.

Referring to FIG. 14, the first polymer solution S1 coated on the first template 310 was pressed by a supporting film 312b. The first polymer solution S1 is cured to form a second template 312 having a convex-concave portion 312a. The supporting film 312b may include a relatively rigid polymer such as polyethylene terephthalate (PET), polycarbonate (PC) or the like.

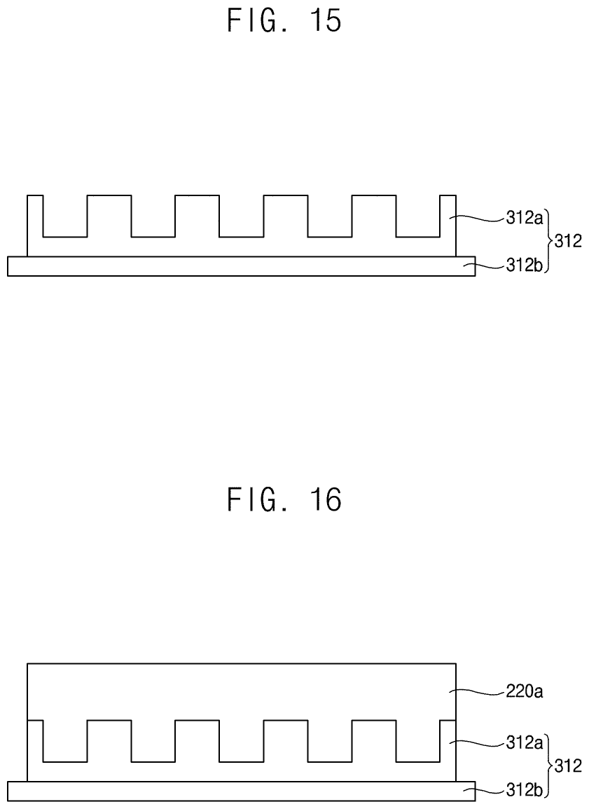

Referring to FIGS. 15 and 16, the second template 312 is separated from the first plate. An elastic material is coated on the convex-concave portion 312a of the second template 312 to form a lattice portion 220a for a phase mask. In an embodiment, the lattice portion 220a may include PDMS.

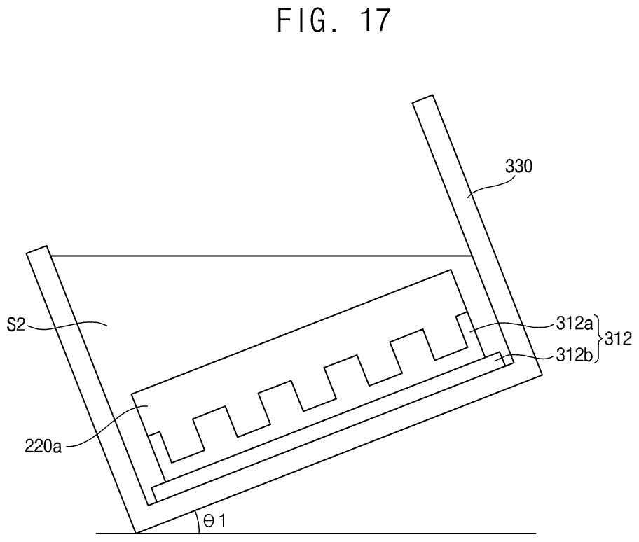

Referring to FIG. 17, the lattice portion 220a with second template 312 is disposed in a container 330 such that a convex-concave surface of the lattice portion 220a faces downwardly. A second polymer solution S2 is provided so that the lattice portion 220a is dipped in the second polymer solution S2. For example, the second polymer solution S2 may include a precursor for PDMS. Components (chain extender or the like) of the second polymer solution S2 may be adjusted so that PDMS formed from the second polymer solution S2 may have a modulus smaller that a modulus of PDMS of lattice portion 220a.

The second polymer solution S2 is cured while the container 330 is tiled such that a bottom surface of the container 330 is inclined by an inclining angle θ2. After the second template 312 is separated from the lattice portion 220a, a cured body obtained from the second polymer solution S2 is cut thereby obtaining a phase mask having a supporting portion with a prism shape, which is illustrated in FIG. 8.

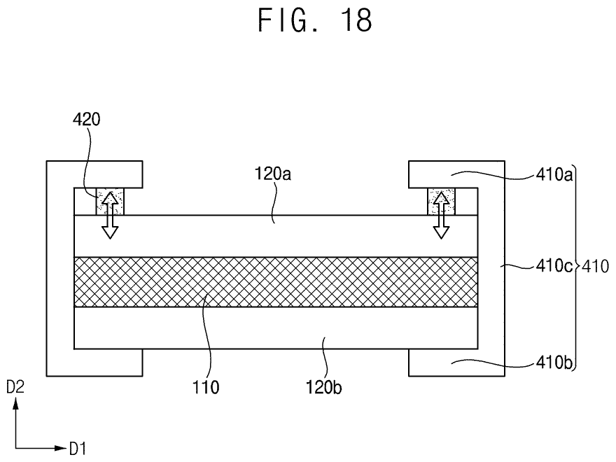

FIG. 18 is a lateral view illustrating a transparency-adjusting apparatus according to another embodiment.

Referring to FIG. 18, a transparency-adjusting apparatus includes a first substrate 120a, a second substrate 120b spaced apart from the first substrate 120a, and a transparency-adjustable film 110 disposed between the first substrate 120a and the second substrate 120b. The first substrate 120a, the second substrate 120b and the transparency-adjustable film 110 may constitute a window assembly.

The transparency-adjusting apparatus further includes a cover member 410 covering an edge of the window assembly. For example, the cover member 410 may include a first portion 410a facing an upper surface of the first substrate 120a, a second portion 410b facing a lower surface of the second substrate 120b and a third portion connecting the first portion 410a and the second portion 410b to each other and extending along a side surface of the window assembly.

A compressive-strain adjusting part 420 may be disposed between the first substrate 120a and the first portion 410a of the cover member 410. The compressive-strain adjusting part 420 may change a length thereof along a vertical direction D2 of the transparency-adjustable film 110 in response to an electric signal or a power, which is applied thereto. As a result, a compressive force applied to the transparency-adjustable film 110 and compressive strain therefrom may be adjusted. The compressive-strain adjusting part 420 may include a driving element such as a motor to adjust a compressive strain.

Hereinafter, effects of embodiments will be explained with reference to experimental results.

### Example 1

Fabricating an Inclining Phased Mask

Polyurea acrylate (PUA) composition (MINS 311RM, Minuta Tech) was coated on a silicon master having an array of circular pillars (pitch: 600 nm, height of a pillar: 420 nm, diameter of a pillar: 480 nm), and pressed by a PET film. After cured, a PUA/PET film was removed from a substrate and attached to a petri dish. A preliminary polymer of h-PDMA (VDT-731, HMS-301, Gelest) was spin-coated on the PUA/PET film and then thermally cured. Thereafter, a PDMS composition (Slygard 184, Dow) wad poured in the petri dish. While the petri dish was tiled by an angle required for a desired incident angle, the petri dish was kept at a room temperature for 1 day for curing and flattening. Thereafter, a phase mask including a pillar array of h-PDMS and a backing layer of s-PDMS was separated from the PUA/PET film, and cut to have a triangular prism shape.

Fabricating a 3D Porous Template

A pre-baked NR photoresist (NR5-6000 and NR7-80P, Futurrex) film was disposed on a convex-concave surface (pillar array) of the phase mask. After baffle was disposed under the mask to reduce a haze at an edge of the mask, a UV ray (355 nm) was exposed through the backing layer (exposing dose energy 250 mJ/cmd to 500 mJ/cmd). Thereafter, a developer (Resist Developer RD6) was provided to obtain a 3D porous template.

Fabricating a Transparency-Adjustable Film

The 3D porous template was disposed on a glass substrate (2.8 cm×2.8 cm), and a PDMS composition (Slygard 184) was spin-coated thereon with 3,000 rpm. The substrate was kept for 1 hour in vacuum so that the composition might uniformly penetrate into the 3D porous template. Thereafter, the PDMS composition was cured at 65° C. for 2 hours, and was dipped in a resist remover (RR41, Futurrex) to remove the 3D porous template thereby obtaining a transparency-adjustable film. An entire thickness of the transparency-adjustable film was about 0.6 mm, and a thickness of a porous layer (porous region) was about 10 μm.

### Comparative Example 1

A transparency-adjustable film was fabricated by a same method as Example 1 except that the petri dish was not tilted (incident angle: 0°) when the phase mask was fabricated.

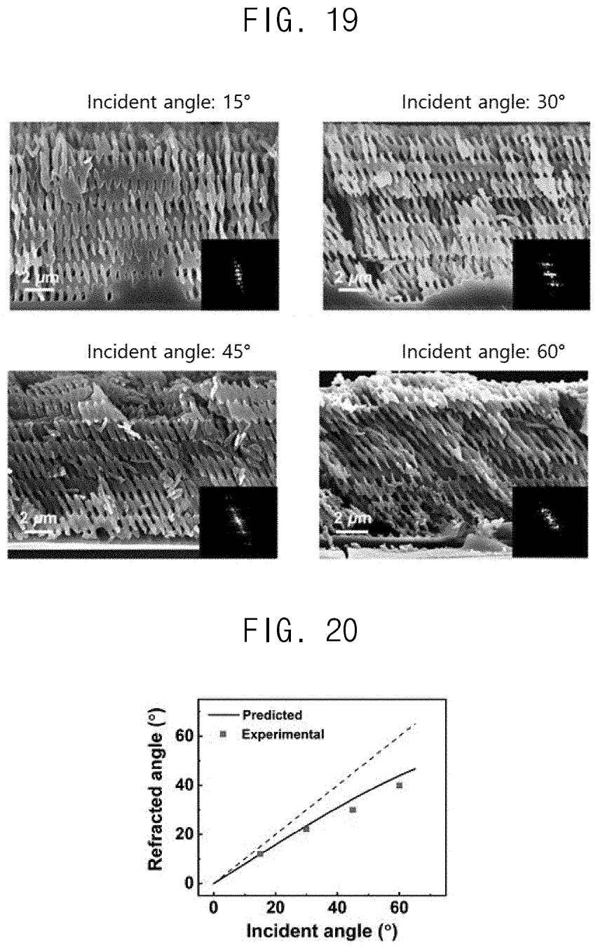

FIG. 19 shows scanning electron microscopy (SEM) photographs showing cross-sections of the transparency-adjustable films obtained with different incident angles in Example 1. FIG. 20 is a graph showing a refracted angle of pores in the transparency-adjustable films obtained with different incident angles in Example 1.

Referring to FIGS. 19 and 20, when the incident angle was 60°, the refracted angle (inclining angle) of pores in the transparency-adjustable film was 40°.

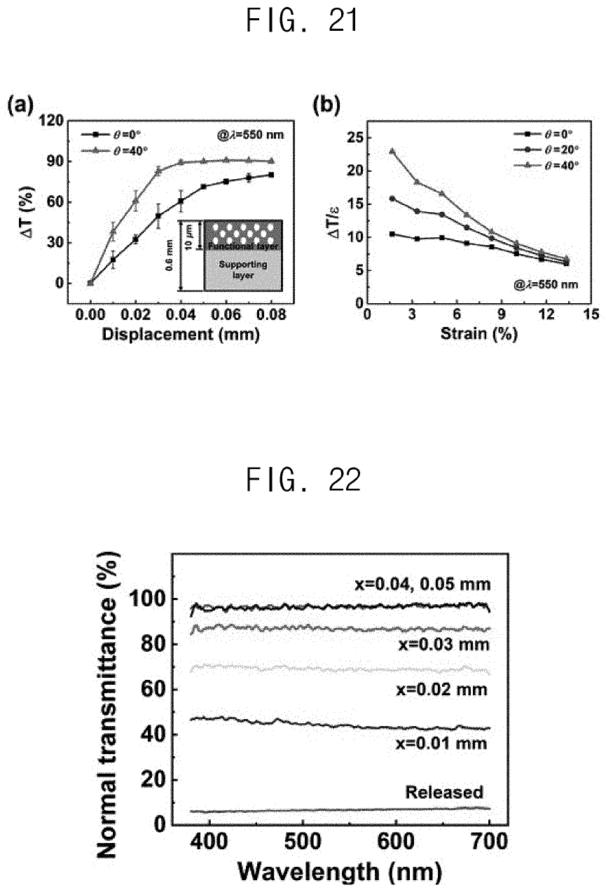

FIG. 21 show graphs showing transparency variance depending on compressive displacement (Displacement) (a) and transparency variance (ΔT/ε) to compressive strain (Strain) (b), of the transparency-adjustable films of Example 1 and Comparative Example 1. FIG. 22 is a graph showing a transmittance depending on a wavelength of a light and displacement of the transparency-adjustable film (refracted angle: 40°) of Example 1.

Referring to FIG. 21, the transparency variance of the transparency-adjustable film having inclining pores was larger than that of the transparency-adjustable film having non-inclining pores. As the refracted angle of the pores was increased, the transparency variance (ΔT/ε) to compressive strain (Strain) was increased.

Referring to FIG. 22, it can be noted that the transparency-adjustable film of Example 1 may uniformly adjust a transparency in an entire range of a visible ray.

A transparency-adjustable film and a transparency-adjusting apparatus according to embodiments may be used for an optical apparatus, a smart window, a projector, a deformable transparent partition, a light-blocking apparatus or the like, and may be applied to a construction, a vehicle (motor vehicle, vessel, aircraft or the like), a home appliance, a display device or the like.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A transparency-adjustable film including a polymer and an array of pores that are three-dimensionally ordered and connected to each other,
wherein the pores have a shape extending in a direction, and an extending direction of the pores tilts from a direction vertical to a plane direction of the transparency-adjustable film.

2. The transparency-adjustable film of claim 1, wherein a tilting angle of the pores is 10° to 45°.

3. The transparency-adjustable film of claim 1, wherein a porosity of the transparency-adjustable film is 30% to 70%.

4. A transparency-adjusting apparatus comprising:
a transparency-adjustable film including a polymer and an array of pores that are three-dimensionally ordered and connected to each other; and
a compressive-strain adjusting part that adjusts a compressive strain of the transparency-adjustable film in a vertical direction,
wherein a transparency of the transparency-adjustable film varies depending on the compressive strain, and wherein the pores are arranged to tilt from the vertical direction.

5. The transparency-adjusting apparatus of claim 4, wherein the transparency-adjustable film includes polydimethylsiloxane.

6. The transparency-adjusting apparatus of claim 4, wherein the pores have a shape extending in a direction, wherein a tilting angle of the pores is defined by an angle between the extending direction and the vertical direction.

7. The transparency-adjusting apparatus of claim 6, wherein the tilting angle of the pores is 10° to 45°.

8. The transparency-adjusting apparatus of claim 4, wherein a porosity of the transparency-adjustable film is 30% to 70%.

9. The transparency-adjusting apparatus of claim 4, wherein the transparency-adjustable film includes a porous region having the pores and a solid region substantially without pores.

10. The transparency-adjusting apparatus of claim 4, further comprising a first substrate disposed on a first surface of the transparency-adjustable film, and a second substrate disposed on a second surface of the transparency-adjustable film.

11. The transparency-adjusting apparatus of claim 10, wherein the compressive-strain adjusting part includes:
a movement member combined with the first substrate; and
a movement guide combined with the second substrate,
wherein the movement member moves along the movement guide in the vertical direction to adjust the compressive strain of the transparency-adjustable film.

12. The transparency-adjusting apparatus of claim 10, wherein the compressive-strain adjusting part includes:
a first transparent electrode between the transparency-adjustable film and the first substrate; and
a second transparent electrode between the transparency-adjustable film and the second substrate,
wherein the first transparent electrode and the second transparent electrode are connected to a voltage-applying part to adjust the compressive strain of the transparency-adjustable film depending on polarities of voltages applied to the first transparent electrode and the second transparent electrode and on a difference between the voltages.

13. The transparency-adjusting apparatus of claim 10, further comprising a cover member that covers edges of the first substrate, the second substrate and the transparency-adjustable film,
wherein the cover member includes a first portion facing an upper surface of the first substrate, a second portion facing a lower surface of the second substrate, and a third portion connecting the first portion and the second portion to each other,
wherein the compressive-strain adjusting part is disposed between the first portion of the cover member and the first substrate, and a vertical length of the compressive-strain adjusting part varies in response to an electric signal or a power applied thereto to adjust the compressive strain of the transparency-adjustable film.
